(19) United States
(12) Patent Application Publication
(10) Pub. No.: US 2018/0008049 A1
(43) Pub. Date: Jan. 11, 2018

(54) FRAME OF ELECTRIC BED

(71) Applicant: Chuan-Hang SHIH, Lu-Kang Town (TW)

(72) Inventor: Chuan-Hang SHIH, Lu-Kang Town (TW)

(21) Appl. No.: 15/203,419

(22) Filed: Jul. 6, 2016

(51) Int. Cl. A47C 20/04; F16B 12/56; A47C 19/02

(52) U.S. Cl. CPC A47C 20/041; A47C 19/025; F16B 12/56

(57) ABSTRACT

A frame of an electric bed for connecting a side plate includes a fixed rack, a movable rack, a leg post, a connecting member and a combining device. The movable rack is moveably disposed at the fixed rack. The leg post is disposed at a bottom of the fixed rack. The connecting member is sandwiched between the fixed rack and the leg post for connecting the side plate. The combining device combines the fixed rack, the connecting member and the leg post together. As a result, it's easy for users to combine the side plate and the frame firmly.

### BACKGROUND OF THE INVENTION

1. Field of the Invention

The present invention relates generally to electric beds and more particularly, to a frame of an electric bed.

### 2. Description of the Related Art

When compared with a traditional bed having a stationary frame, an electric bed has a frame which can lift a specific body portion, such as shanks, thighs, or back, etc. by users, so that the users can change a reclining posture freely, and the comfortableness would be enhanced. In addition, some electric beds may have some leg posts to elevate the heights of the beds, so that it's convenient for users to get on and get off the electric beds. However, these electric beds having the leg posts may be less beautiful because it's easier for users to observe part of frames of beds from a side view. Besides, it's easier for young children to reach under the electric beds, which may result in accidents during operations of the electric beds by users. Therefore, users may try to purchase side plates or frames which are to be disposed at sides of the electric beds, so as to achieve effect of covering or appearance improvement. However, these side plates may not be original accessories of electric bed, thus it may be not easy to fix the side plates on the electric bed. The side plates may be easier to be fallen away from the electric bed by collision if the side plates are not fixed on the electric bed firmly. On the other hand, although some fixing methods such as pinning or welding may fix the side plates on the electric bed firmly, but the appearance of the electric bed may be less beautiful after disposing the side plates by those users having no professional decorating skill, it's hard to remove the fixed side plates, and even some decorating marks would be remained on the electric bed after removing the side plates. Accordingly, there would need an electric bed which can be combined with side plates firmly in a convenient way and would not affect the appearance of the electric bed after users remove the side plates.

### SUMMARY OF THE INVENTION

The present invention has been accomplished in view of the above-noted circumstances. It is an objective of the present invention to provide a frame of an electric bed which can be combined with side plates firmly with convenience and help users to remove the side plates freely and easily.

To attain the above objective, the present invention provides a frame of an electric bed adapted for connecting a side plate, the frame includes a fixed rack, a movable rack, a leg post, a connecting member and a combining device. The movable rack is moveably disposed at the fixed rack. The leg post is disposed at a bottom of the fixed rack. The connecting member is sandwiched between the fixed rack and the leg post for connecting the side plate. The combining device combines the fixed rack, the connecting member and the leg post.

Accordingly, users can combine the connecting member with other members of the frame by the combining device, then the purchased side plates can be fixed on the connecting member, the assembly operation would be finished with ease, and the side plates can be fixed on the sides of the electric bed. On the other hand, it's convenient for users to change other side plates, so that the users can combine a suitable side plate elastically according to users' demands. In addition, the connecting member can be removed with the side plates directly if users do not want to dispose the side plates, and decorating mark would not be remained on the electric bed.

### BRIEF DESCRIPTION OF THE DRAWINGS

FIG. 1 is a perspective view of an electric bed according to a first preferred embodiment of the present invention.

FIG. 2 is another perspective view of the electric bed according to the first preferred embodiment of the present invention, showing a top a frame without four supporting boards.

FIG. 3 is another perspective view of the electric bed according to the first preferred embodiment of the present invention.

FIG. 4 is a side view of the electric bed according to the first preferred embodiment of the present invention, showing the function of the electric bed.

FIG. 5 is an exploded perspective view of a part of the electric bed of the first embodiment of the present invention.

FIG. 6 is a sectional view of a part of the electric bed of the first embodiment of the present invention.

FIG. 7 is an exploded perspective view of a part of the electric bed of a second embodiment of the present invention.

### DETAILED DESCRIPTION OF THE INVENTION

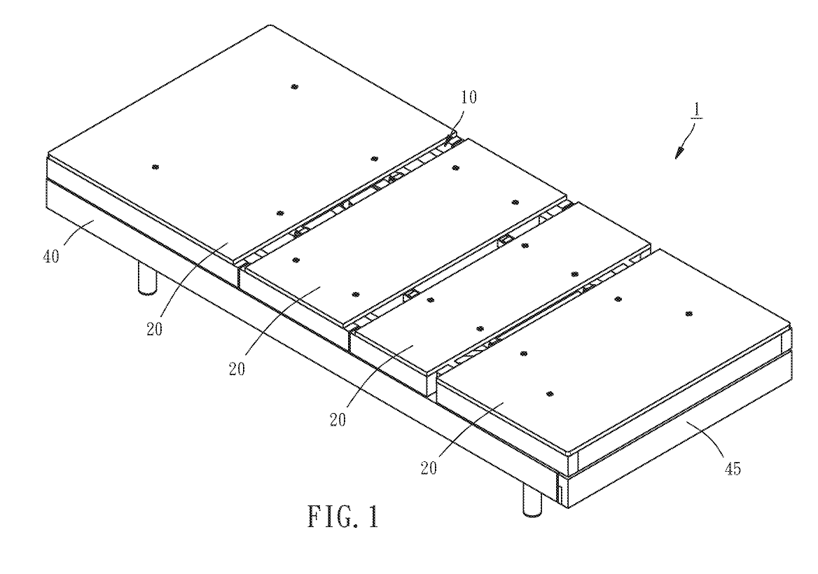

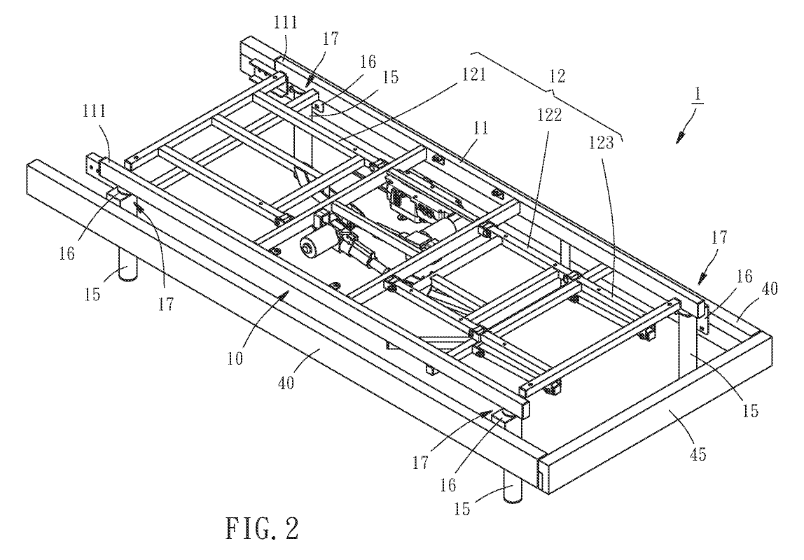

Referring to FIGS. 1 to 3, an electric bed 1 according to a first preferred embodiment of the present invention includes a frame 10 and four supporting boards 20. The electric bed 1 is adapted for a mattress (not shown) to be placed on the four supporting boards 20.

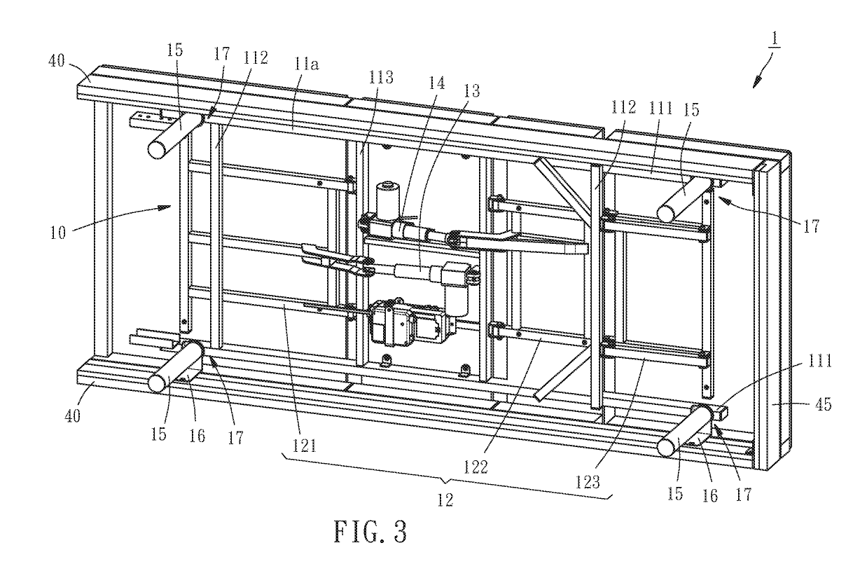

In the following, the left direction of FIG. 3 would be defined as a front direction of the electric bed 1, the upper direction of FIG. 3 would be defined as a left direction of the electric bed 1, and so on. The frame 10 is adapted for connecting two side plates 40 (guard plates or bed frame) and includes a fixed rack 11, a movable rack 12, a first actuator 13, a second actuator 14, four leg posts 15, four connecting members 16 and four combining devices 17.

The fixed rack 11 has two supporting rods 111 extending along the longitudinal direction of the frame 10, two connecting rods 112 whose two ends connected with the two supporting rods 111, and a hip rack 113 whose two ends connected with the two supporting rods 111 and located correspondingly to user's hips.

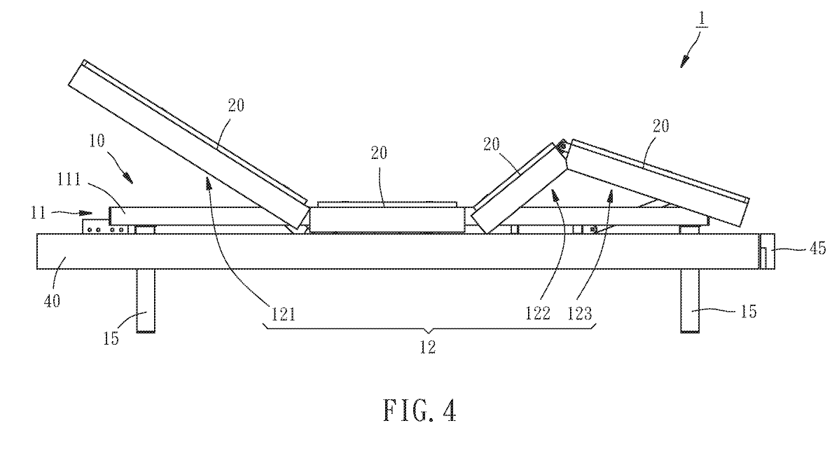

Referring to FIGS. 3 and 4, the movable rack 12 means a structure which can be swung or moved relative to the fixed rack 11. In this embodiment, the movable rack 12 has a back rack 121 moveably disposed at a front side of the hip rack 113 of the fixed rack 11, a thigh rack 122 moveably disposed at a rear side of the hip rack 113, and a shank rack 123 moveably disposed at a rear side of the thigh rack 122. The back rack 121, the thigh rack 122, and the shank rack 123 are located correspondingly to user's back, thighs, and shanks, respectively. The first actuator 13 has two ends which are rotatably connected with the fixed rack 11 and the back rack 121, and the first actuator 13 can drive the back rack 121 to be swung relative to the fixed rack 11, so as to lift or lower user's hack. The second actuator 14 has two ends which are rotatably connected with the fixed rack 11 and the thigh rack 122, and the second actuator 14 can drive the thigh rack 122 to be swung relative to the fixed rack 11, so as to lift or lower user's thighs. In other embodiments, the movable rack 12 can be another rack body movable relative to the fixed rack 11.

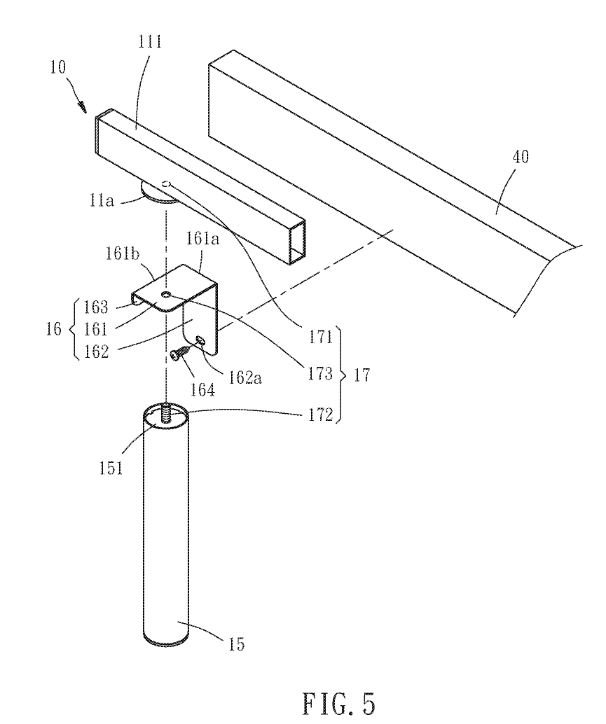

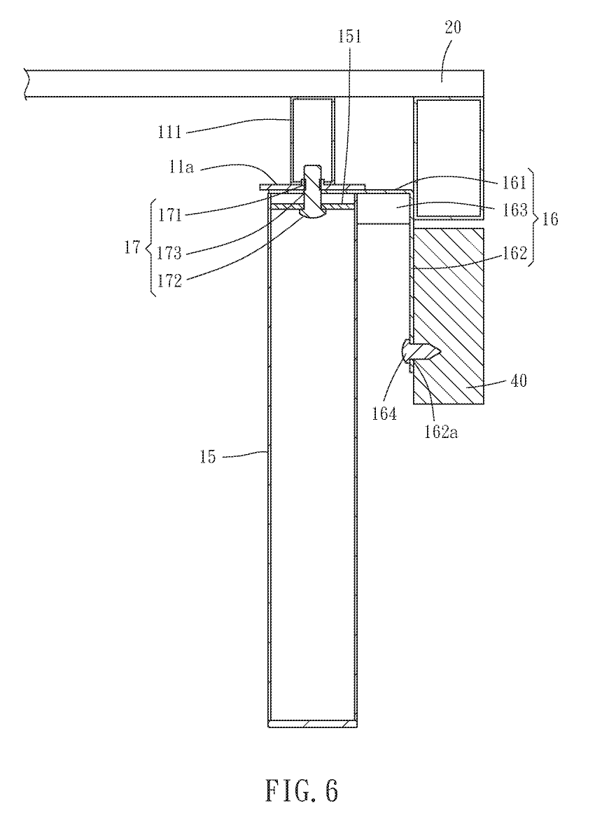

The four leg posts 15 are disposed at a bottom 11a of the fixed rack 11 and extending downwardly from the fixed rack 11. Referring to FIGS. 5 and 6, two leg posts 15 are disposed at a bottom of each supporting rod 111

The four connecting members 16 are respectively sandwiched between the fixed rack 11 and the corresponding leg posts 15 for connecting the two side plates 40 as shown in FIG. 5. In this embodiment, each of the connecting members 16 has a horizontally extending portion 161 sandwiched between the fixed rack 11 and the corresponding leg post 15, a side connecting portion 162 extending downwardly from an end 161a of the horizontally extending portion 161, and a reinforcement plate 163 extending vertically and downwardly from a side 161b of the horizontally extending portion 161 and abutting against the side connecting portion 162. The side connecting portion 162 vertically extends from the end 161a of the horizontally extending portion 161, so that the connecting member 16 is L-shaped. The side connecting portion 162 is adapted for connecting the side plate 40. Each side connecting portion 162 has a second through hole 162a for being inserted by a screw 164, and the screw 164 is screwingly threaded into the corresponding side plate 40, so as to combine the connecting member 16 with the side plate 40. Accordingly, user merely need to make the two side plates 40 abut against the sides of the corresponding side connecting portions 162, then user aligns the screw 164 with the second through hole 162a and screws the screw 164 to each side plate 40, and the two side plates 40 can be fixed on the frame 10 with ease, so as to improve appearance and safety. On the other hand, user can change other side plates by loosening the screw 164, so as improve the elasticity of repairing and changing members.

It should be noticed that, in other embodiments, the structures of these connecting members 16 can be modified. For examples, oblique supporting plate or rack may be disposed between the horizontally extending portion 161 and the side connecting portion 162 and etc., based on that these connecting members 16 can be fixed on the fixed rack 11 and combined with the side plates 40 firmly, Another side connecting portion 162 may be disposed at another side of the horizontally extending portion 161, and the horizontally extending portion 161 may be extended to a rear plate 45 for connecting the rear plate 45. Another reinforcement plate 163 may be disposed at another side of the horizontally extending portion 161 or eliminated. The second through hole 162a of the side connecting portion 162 may be inserted by a bolt (not shown) penetrating through a corresponding side plate 40, and the bolt is screwingly threaded into a nut (not shown) and fixed on the corresponding side plate 40. The numbers and locations of the second through hole 162a and the screw member 164 can be modified accordingly.

Each combining device 17 includes a screw hole 171 disposed at the bottom 11a of the fixed rack 11, a screw rod 172 fixed at a top end 151 of the leg post 15 (by welding, gluing, or other fixing techniques) and extending upwardly from the leg post 15, and a first through hole 173 disposed at the horizontally extending portion 161 of the connecting member 16. The screw rod 172 is located correspondingly to the first through hole 173, inserted upwardly through the first through hole 173, and screwingly threaded into the screw hole 171, so as to combine the fixed rack 11, the connecting member 16 and the leg post 15. Accordingly, when user wants to dispose the two side plates 40 on the electric bed 1, just aligning the screw rod 172 of each leg post 15 with the corresponding first through hole 173 and screw hole 171 and screwing the screw rod 172 to fixed rack 11 until tight, so as to help user to further dispose the two side plates 40. On the other hand, when user do not want to use the two side plates 40, just removing the leg post 15 from the fixed rack 11, and then the connecting member 16 can be removed with the two side plates 40, so as to reduce difficulty of disassembly. After user reassemble the leg post 15, decorating mark caused by the two side plates 40 would not be seen on the frame 10.

It should be noticed that, the first through hole 173 and the second through hole 162a of the connecting member 16 can be elongated holes, to adapt for different thicknesses of the side plates 40 and help user to adjust the two side plates 40 to be flush with the sides of the electric bed 1.

In addition, the four supporting boards 20 are disposed on tops of the hip rack 113 of the fixed rack 11, the movable rack 12, the thigh rack 122, and the shank rack 123, respectively. The two side plates 40 and the rear plate 45 may be for example wood plates, melamine boards, or even cushioning objects containing foam, soft mattress, and etc., to prevent user from injury caused by accidental collision.

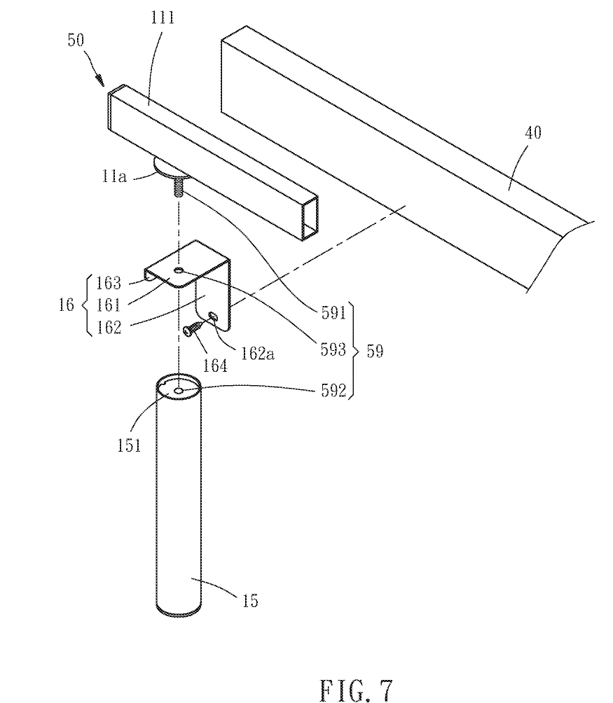

On the other hand, the structure of the combining device 17 can be modified. For example, referring to FIG. 7 which illustrates a frame 50 of a second preferred embodiment of the present invention, the differences between the frame 50 and the first preferred embodiment are that each combining device 59 includes a screw rod 591 disposed at the bottom 11a of the supporting rod 111 and extending downwardly from the supporting rod 111, a screw hole 592 disposed at the top end 151 of the leg post 15, and a first through hole 593 disposed at the horizontally extending portion 161 of the connecting member 16. The screw rod 591 is located correspondingly to the screw hole 592 and the first through hole 593, inserted downwardly through the through hole 593, and screwingly threaded into the screw hole 592, so as to combine the fixed rack 11, the connecting member 16 and the leg post 15. Accordingly, user merely need to screw the leg post 15 to the fixed rack 11 or loosen the leg post 15 from the fixed rack 11, then each connecting member 16 can be combined or removed easily and freely.

It should be noticed that, the first through hole 593 may be an elongated hole, to help user to adjust the two side plates 40 to be flush with the sides of the electric bed 1. The two connecting members 16 is adapted for connecting. the two side plates 40 in the first and second preferred embodiments, however, this structure may be applied to connect the rear plate 45 or a front plate (not shown) located at the opposite side of the rear plate 45. In addition, the leg posts 15 can be combined with the connecting member 16 and the fixed rack 11 by any embedding structure or a combination of bolt and nut.

The above description represents merely the preferred embodiment of the present invention, without any intention to limit the scope of the present invention. The simple variations and modifications not to be regarded as a departure from the spirit of the invention are intended to be included within the scope of the following claims.

What is claimed is:

1. A frame of an electric bed, adapted for connecting a side plate, the frame of the electric bed comprising:
a fixed rack;
a movable rack, moveably disposed at the fixed rack;
a leg post, disposed at a bottom of the fixed rack;
a connecting member, sandwiched between the fixed rack and the leg post for connecting the side plate; and
a combining device, combining the fixed rack, the connecting member, and the leg post.

2. The frame of the electric bed as claimed in claim , wherein the combining device comprises a screw hole disposed at the bottom of the fixed rack, a screw rod fixed at a top end of the leg post, and a first through hole disposed at the connecting member; the screw rod is inserted through the first through hole and screwingly threaded into the screw hole.

3. The frame of the electric bed as claimed in claim 2, wherein the first through hole is an elongated hole.

4. The frame of the electric bed as claimed in chat I. wherein the combining device comprises a screw rod disposed at the fixed rack, a screw hole disposed at a top end of the leg post, and a first through hole disposed at the connecting member; the screw rod is inserted through the first through hole and screwingly threaded into the screw hole.

5. The frame of the electric bed as claimed in claim 4, wherein the first through hole is an elongated hole.

6. The frame of the electric bed as claimed in claim 1, wherein the connecting member has a horizontally extending portion sandwiched between the fixed rack and the leg post, and a side connecting portion extending from an end of the horizontally extending portion for connecting the side plate.

7. The frame of the electric bed as claimed in claim 6, wherein the side connecting portion vertically extends from the end of the horizontally extending portion, so that the connecting member is L-shaped.

8. The frame of the electric bed as claimed in claim 6, wherein the side connecting portion has a second through hole.

9. The frame of the electric bed as claimed in claim 6, wherein the connecting member further has at least one reinforcement plate extending vertically from the horizontally extending portion and abutting against the side connecting portion.
